(19) United States
(12) Patent Application Publication
(10) Pub. No.: US 2023/0121374 A1
(43) Pub. Date: Apr. 20, 2023

(54) SYSTEMS AND METHODS FOR ROBUST WATERMARKING OF DEEP NEURAL NETWORKS

(71) Applicant: Baidu USA, LLC, Sunnyvale, CA (US)

(72) Inventors: Peng YANG, Bellevue, WA (US); Yingjie LAO, Clemson, SC (US); Ping LI, Bellevue, WA (US)

(73) Assignee: Baidu USA LLC, Sunnyvale, CA (US)

(21) Appl. No.: 17/491,517

(22) Filed: Sep. 30, 2021

(51) Int. Cl. G06N 3/08

(52) U.S. Cl. CPC G06N 3/084

(57) ABSTRACT

Presented herein are embodiments of a bi-level optimization framework an inner loop phase optimizes an example-level problem to generate robust exemplars, while an outer loop phase proposes an adaptive optimization to achieve the robustness of the projected DNN models. Embodiments for watermarking a deep neural network include obtaining a set of temporary parameters for a temporary model. The set of temporary parameters may be generated based upon a set of base parameters of a base model. Embodiments may further include generating a set of boundary watermark exemplars using the set of temporary parameters for the temporary model. In one or more embodiments, the set of boundary watermark exemplars maximizes an identification loss of the temporary model on a set of watermark data. Embodiments may further include outputting a watermark embedded base model by embedding the set of boundary watermark exemplars into one or more base parameters of the base model.

### BACKGROUND

### A. Technical Field

The present disclosure relates generally to systems and methods for computer learning that can provide improved computer performance, features, and uses. More particularly, the present disclosure relates to systems and methods for robust watermarking for deep neural networks.

### B. Background

Deep neural networks (DNNs) have achieved great successes in many domains, such as computer vision, natural language processing, recommender systems, etc. Along with the unprecedented progress of deep neural networks, both the networks and application tasks have become increasingly sophisticated, making the models costly to build. As a result, DNN models are considered valuable assets, which demand a means for protecting the intellectual property (IP) of model builders. To this end, several DNN watermarking or fingerprinting approaches have been developed.

Conceptually, watermarking of DNNs is achieved by injecting certain behavior into the model, where such behavior can be easily verified later. Existing DNN watermarking techniques include “black-box” watermarking and “white-box” watermarking. Under black-box watermarking techniques, the watermarking processes associate desired predictions to injected key samples that are different from predictions that would be output by naturally trained models (e.g., by using backdoor) to reduce the false positive rate (i.e., probability of detecting the presence of the watermarking in a naturally trained model). White-box watermarking requires full access to the DNN model, thus enabling a flexible watermark embedding and extraction process to enable the desired behavior to be embedded into the internal structure or latent space of a DNN model.

Although white-box watermarking can provide many benefits, the utility of white-box techniques is somewhat limited in view of the need for full access to the DNN model for watermark extraction. Furthermore, black-box watermarking techniques may bring about unexpected modification to the learned function of the DNN model during the process of injecting key samples into the model, which may lead to performance degradation.

Furthermore, watermarked DNN models can be subjected to subsequent modifications and/or attacks that can potentially undermine watermarks embedded into the DNN models. Example transformation attacks include fine-tuning, pruning, and watermark overwriting processes. Although some existing watermarking techniques have shown the ability to withstand certain attacks, robustness is not an underlying optimization objective of existing watermark embedding processes.

Accordingly, what is needed are improved systems, methods, and techniques for facilitating watermarking of DNN models in a manner that preserves model functionality while providing robustness against subsequent transformation attacks.

### BRIEF DESCRIPTION OF THE DRAWINGS

References will be made to embodiments of the disclosure, examples of which may be illustrated in the accompanying figures. These figures are intended to be illustrative, not limiting. Although the disclosure is generally described in the context of these embodiments, it should be understood that it is not intended to limit the scope of the disclosure to these particular embodiments. Items in the figures may not be to scale.

Figure FIG. 1 depicts a conceptual representation of bi-level optimization schema, according to embodiments of the present disclosure.

FIG. 2 depicts a conceptual representation of an inner loop optimization flow, according to embodiments of the present disclosure.

FIG. 3 depicts an example flow diagram showing example acts associated with bi-level optimization for DNN watermarking, according to embodiments of the present disclosure.

FIGS. 4 and 5 depict example flow diagrams showing acts associated with watermarking a deep neural network, according to embodiments of the present disclosure.

FIG. 6 depicts an example flow diagram showing acts associated with detecting a watermarked deep neural network, according to embodiments of the present disclosure.

FIG. 7 depicts a table showing experimental results on effectiveness and fidelity, according to embodiments of the present disclosure.

FIG. 8 depicts graphs indicating ratios of changed parameters over experimental DNN models with respect to different numbers of key samples, according to embodiments of the present disclosure.

FIG. 9 depicts experimental signature preserving rates and function preserving rates under the process of fine-tuning on validated datasets, according to embodiments of the present disclosure.

FIG. 10 depicts experimental authentication and function preserve rates under various pruning rates, according to embodiments of the present disclosure.

FIG. 11 depicts experimental signature preserving rates and function preserving rates under processes of overwriting, according to embodiments of the present disclosure.

FIG. 12 depicts experimental evaluations of sequential single input overwriting, according to embodiments of the present disclosure.

FIG. 13 depicts experimental authentication success rate and function preserved rate with various numbers of watermark embedding, according to embodiments of the present disclosure.

FIG. 14 depicts a table showing a comparison between the disclosed techniques and existing watermarking techniques on fidelity and robustness against overwriting, according to embodiments of the present disclosure.

FIG. 15 depicts a simplified block diagram of a computing device/information handling system, according to embodiments of the present disclosure.

### DETAILED DESCRIPTION OF EMBODIMENTS

In the following description, for purposes of explanation, specific details are set forth in order to provide an understanding of the disclosure. It will be apparent, however, to one skilled in the art that the disclosure can be practiced without these details. Furthermore, one skilled in the art will recognize that embodiments of the present disclosure, described below, may be implemented in a variety of ways, such as a process, an apparatus, a system, a device, or a method on a tangible computer-readable medium.

Components, or modules, shown in diagrams are illustrative of exemplary embodiments of the disclosure and are meant to avoid obscuring the disclosure. It shall be understood that throughout this discussion that components may be described as separate functional units, which may comprise sub-units, but those skilled in the art will recognize that various components, or portions thereof, may be divided into separate components or may be integrated together, including, for example, being in a single system or component. It should be noted that functions or operations discussed herein may be implemented as components. Components may be implemented in software, hardware, or a combination thereof.

Furthermore, connections between components or systems within the FIGS. are not intended to be limited to direct connections. Rather, data between these components may be modified, re-formatted, or otherwise changed by intermediary components. Also, additional or fewer connections may be used. It shall also be noted that the terms “coupled,” “connected,” “communicatively coupled,” “interfacing,” “interface,” or any of their derivatives shall be understood to include direct connections, indirect connections through one or more intermediary devices, and wireless connections. It shall also be noted that any communication, such as a signal, response, reply, acknowledgement, message, query, etc., may comprise one or more exchanges of information.

Reference in the specification to “one or more embodiments,” “preferred embodiment,” “an embodiment,” “embodiments,” or the like means that a particular feature, structure, characteristic, or function described in connection with the embodiment is included in at least one embodiment of the disclosure and may be in more than one embodiment. Also, the appearances of the above-noted phrases in various places in the specification are not necessarily all referring to the same embodiment or embodiments.

The use of certain terms in various places in the specification is for illustration and should not be construed as limiting. A service, function, or resource is not limited to a single service, function, or resource; usage of these terms may refer to a grouping of related services, functions, or resources, which may be distributed or aggregated. The terms “include,” “including,” “comprise,” “comprising,” or any of their variants shall be understood to be open terms, and any lists of items that follow are example items and not meant to be limited to the listed items. A “layer” may comprise one or more operations. The words “optimal,” “optimize,” “optimization,” and the like refer to an improvement of an outcome or a process and do not require that the specified outcome or process has achieved an “optimal” or peak state. The use of memory, database, information base, data store, tables, hardware, cache, and the like may be used herein to refer to system component or components into which information may be entered or otherwise recorded.

In one or more embodiments, a stop condition may include: (1) a set number of iterations have been performed; (2) an amount of processing time has been reached; (3) convergence (e.g., the difference between consecutive iterations is less than a first threshold value); (4) divergence (e.g., the performance deteriorates); (5) an acceptable outcome has been reached; and (6) all of the data has been processed.

One skilled in the art shall recognize that: (1) certain steps may optionally be performed; (2) steps may not be limited to the specific order set forth herein; (3) certain steps may be performed in different orders; and (4) certain steps may be done concurrently.

Any headings used herein are for organizational purposes only and shall not be used to limit the scope of the description or the claims. Each reference/document mentioned in this patent document is incorporated by reference herein in its entirety.

It shall be noted that any experiments and results provided herein are provided by way of illustration and were performed under specific conditions using a specific embodiment or embodiments; accordingly, neither these experiments nor their results shall be used to limit the scope of the disclosure of the current patent document.

### A. General Introduction

Deep neural networks (DNNs) have become state-of-the-art in many application domains. The increasing complexity and cost for building these models demand means for protecting their intellectual property. Disclosed embodiments provide a novel DNN framework that optimizes the robustness of the embedded watermarks. Different from existing end-to-end DNN watermarking approaches, disclosed techniques include modifying a tiny subset of weights to embed the watermark, which also facilitate better control of the model behaviors and enables larger room for optimizing the robustness of the watermarks.

Disclosed techniques implement a bi-level optimization framework where an inner loop phase optimizes the example-level problem to generate robust exemplars, while an outer loop phase utilizes an adaptive optimization, which may be masked, to achieve the robustness of the projected DNN models. Embodiments may alternate the learning of the protected models and watermark exemplars across all phases, where watermark exemplars are not just data samples that could be optimized and/or adjusted. The principles disclosed herein are applicable to a wide range of datasets and DNN architectures. Experimental data (provided hereinbelow) indicates that DNN models that are watermarked according to the principles disclosed herein are robust against various transformation attacks including fine-tuning, pruning, and over-writing.

In contrast with existing DNN watermarking methods that rely on end-to-end retraining or re-tuning of the key samples with desired labels, at least some embodiments provide a novel framework that modifies an extremely small number of parameters for embedding a watermark. In one or more embodiments, instead of just constraining the selection of key samples, the parameter modifications in the watermarking process are further constrained. Watermarks that are embedded according to the present disclosure may be identified/extracted similar to watermarks embedded under conventional black-box techniques, such as by remote querying using a model prediction API (application programming interface).

At least some disclosed embodiments leverage techniques from fault attacks. Fault attacks are capable of catastrophically degrading the inference accuracy by directly injecting faults into DNN model parameters. These attacks typically search for the most vulnerable weights/bits that can significantly degrade the inference accuracy. For example, fault attacks can drastically reduce the inference accuracy by flipping only a few bits in memory cells. Faults can also be injected into the activation function of a DNN to manipulate the label of a specific input.

At least some techniques from fault attacks can be adapted for embedding watermarks, such as by searching for parameters that have large magnitudes of gradients with respect to key samples while close to zero-valued gradients with respect to natural inputs. In some instances, only modifying these weights enables improved the robustness of the watermarks without affecting the normal behavior with respect to natural inputs.

At least some embodiments further include optimization and active learning processes to enhance the robustness of the model behavior with respect to key samples after embedding. By making robustness an underlying optimization objective, in contrast with prior works, the disclosed framework may provide more potential toward robust DNN watermarking. At least some disclosed embodiments may also significantly reduce watermarking overhead, as only a very small portion of the network may require modification. Furthermore, at least some principles disclosed herein may be advantageously applied to watermark DNN models that have already been deployed.

Some technical benefits and/or contributions facilitated by at least some of the disclosed embodiments may be summarized as follows: (1) disclosed embodiments provide an effective and efficient bi-level optimization framework for DNN watermarking that generates robust exemplars and embeds the watermark concurrently, as opposed to prior techniques that consider them as two separate processes; (2) disclosed embodiments enhance robustness by formulating the watermarking as two alternative optimization phases: an inner loop phase that optimizes the example-level problem to generate robust exemplars according to the predictive confidence toward the current hypothesis, and an outer loop phase that implements a masked adaptive optimization to achieve the robustness of the projected DNN model; (3) disclosed embodiments facilitate effectiveness on various DNN models (e.g., VGG-9, VGG-16, and Inception-V3) and robustness against transformation attacks, as indicated by experimental results provided hereinbelow; and (4) disclosed embodiments enable improved watermark robustness without affecting normal model behavior by only modifying weights that have large magnitudes of gradients with respect to key samples while close to zero-valued gradients with respect to natural inputs.

### B. Conceptual Examples of Implementations

The disclosed watermarking embodiments may be conducted by a model builder and/or a trusted party. For example, a pre-trained model may be received from a model builder who builds a model architecture F and corresponding parameters with the training dataset Dₜᵣ, and a held-out validation dataset Dᵥ for evaluating the performance. A watermarking process embodiment as discussed herein may then be applied to the received DNN model to embed one or more desired watermarks. Only the legitimate model owner knows the specific embedded watermark.

An adversary might subsequently apply transformation attacks in an attempt to remove the embedded but unknown watermark from the DNN model while retaining the underlying functionality of the DNN model. The attacks may include, for instance, model compression, model fine-tuning, and/or watermark over-writing. Stated differently, the attacker may attempt to use the model while avoiding IP tracing and preserving model performance. In some instances, the attacker is able to fully access to the model but has no knowledge of the embedded watermark.

After watermarking, the presence of the watermark may be verified by using the key samples via the prediction API. If the returned signature or label is same or very close to that of the legitimate model owner, it indicates that the model originated with the legitimate model owner. Thus, the legitimate model owner may determine if subsequent users of the model misappropriated the model from the legitimate owner, and the legitimate owner may take appropriate action to remedy the unauthorized use and/or acquisition of the model. In some instances, the watermark may additionally or alternatively be used to determine the identity of the legitimate owner of the model (e.g., if the model is used for illegal activities).

### C. Embodiments for Robust Watermarking of Deep Neural Networks

Given a pre-trained model parameter Θₚᵣₑ , the goal of watermarking may be regarded as generating key samples D_{wm} and embed them successfully without adjusting the parameters that are relevant to the inference performance for normal input data. Specifically, the key samples D_{wm} may be constrained to satisfy two criteria: 1) Manipulation on Labels (the labels of key samples should be easily manipulable by the authenticated DNN model) and 2) Original Function Preservation (the process of key embedding should have little or no negative impacts on the original functionality of the DNN model). To meet the criteria, at least some disclosed embodiments involve exploiting the prediction entropy, which measures the uncertainty or confidence inherent in the model prediction. Samples with high entropy may be selected as the key samples, since these samples are near to one or more decision boundaries, and the model could easily manipulate their labels with a slight modification, which may have few impacts on the original functionality of the pretrained DNN model.

By utilizing the concept from fault attacks that search for parameters to modify, disclosed embodiments may provide an effective bi-level optimization framework for robust watermarking of DNNs. Due to the difference in the settings between attack and defense as discussed above, watermarking possesses different constraints and requirements compared to fault attacks. Having these in mind, disclosed watermarking processes may comprise two alternative optimization phases: the inner loop phase (which optimizes the example-level problem to generate robust exemplars according to the current hypothesis), and the outer loop phase (which deploys a masked adaptive optimization for watermarking). Disclosed methods may provide beneficial solutions in the trade-off space between the watermarking and model functionality.

### 1. Global Bi-Level Optimization Schema

Attention is now directed to FIG. 1, which illustrates a conceptual representation of bi-level optimization schema 100. As illustrated in FIG. 1, the robust watermarking training, according to the present disclosure, involves alternating the learning of predictive models and robust exemplars across all phases, where robust exemplars are not just key samples but could be optimized and/or adjusted instead. FIG. 1 illustrates this alternative learning with a global bi-level optimization schema comprising a model-level problem 102 (including a model optimization process 104) and an exemplar-level problem 106 (including a robust exemplar generation process 108), the solutions of which may be derived to facilitate watermarking.

In watermark embedding, the protected model may be incrementally learned in each phase on the union of watermark exemplars and training data. In turn, based on this model, the watermark exemplars (i.e., the parameters of the exemplars) are adjusted (or learned) before embedding into the protected model. In this way, the objective of watermarking derives a constraint to optimize and adjust the exemplars, and vise-versa. This relationship may be formulated under a global bi-level optimization schema, in which each phase uses the optimal model to optimize watermark exemplars, and vice versa (as represented in FIG. 1).

For example, in the i-th phase, embodiments of the present disclosure may involve aiming to learn a model 110 (Θᵢ) to approximate the ideal authenticated model parameters

$${Θ}_{i}^{∗} ,$$

which is to achieve a trade-off between the prediction on natural input 112 (Dₜᵣ) and the recognition on watermarks 114 (D_{wm}), i.e.,

$${Θ}_{i}^{∗} = {arg min}_{{Θ}_{i}} {L}_{c} \left({Θ}_{i} ; {D}_{t r} ∪ {D}_{w m}\right) ,$$

where the objective function aims to balance the mistake on the ownership identification and the mistake on model predictive function, while the L_{c}(·) denotes the loss function for classification or regression tasks.

Since the key samples D_{wm} are required to be embedded into the model, the boundary exemplars 116 (S_{wm}) are generated that maximize the identification loss on D_{wm}. In this way, the exemplars S_{wm} may be regarded as the “worst cases” of D_{wm}. This may be formulated with the global bi-level optimization problem, where “global” means operating through all phases, as follows,

$$\begin{matrix}{Θ}_{i + 1} = {arg min}_{{Θ}_{i}} {L}_{c} \left({Θ}_{i} ; {D}_{t r} ∪ {S}_{w m}\right) \\ \text{s} \text{.t} \text{.} {S}_{w m} = {arg max}_{{S}_{w m}} {L}_{c} \left({Θ}_{i} ; {D}_{w m}\right) .\end{matrix}$$

Θᵢ₊₁ is the optimal solution on the union of S_{wm} and Dₜᵣ. It reduces the bias caused by natural input Dₜᵣ meanwhile enforcing the exemplars S_{wm} embedded into the model. As used herein, problem (1) denoted above for solving Θ (i.e., the model 110) and S_{wm} (i.e., the exemplars 116) are called model-level and exemplar-level problems, respectively.

### 2. Model-Level Problem (Outer Loop Embodiments)

As illustrated in FIG. 1, in the i-th phase, the model-level problem may be solved with the natural data 112 (Dₜᵣ) and watermarks 114 (D_{wm}) as the input, and use Θᵢ as the model initialization. According to problem (1), the objective function can be expressed as

$${L}_{a l l} = λ {L}_{c} \left({Θ}_{i} ; {D}_{t r}\right) + \left(1 - λ\right) {L}_{c} \left({Θ}_{i} ; {S}_{w m}\right) ,$$

where L_{c}(Θᵢ; Dₜᵣ) denotes the prediction loss on Dₜᵣ, L_{c}(Θ;S_{wm}) the identification loss on S_{wm}, and λ ε [0,1] is a trade-off parameter. Where α₁ comprises a learning rate, Θᵢ may be updated with gradient descent as

$${Θ}_{i + 1} ← {Θ}_{i} - {α}_{1} {∇}_{Θ} {L}_{a l l} .$$

Subsequently, in one or more embodiments, Θᵢ₊₁ may be used to learn the robust exemplars 116 (see FIG. 1), which may be formulated to solve the following problem:

$${S}_{w m} = {arg max}_{{S}_{w m}} {L}_{c} \left({Θ}_{i + 1 ;} {D}_{w m}\right)$$

which may comprise optimizing and adjusting the exemplars with the identification loss of Θᵢ₊₁ on D_{wm}.

### 3. Exemplar-Level Problem (Inner Loop Embodiments)

Although some existing watermarking techniques authenticate the ownership of a model by utilizing a few watermark examples, there is no guarantee that these watermarks are robustly embedded. In contrast, embodiments herein explicitly aim to ensure a feasible approximation of that assumption, thanks to the differentiability of the exemplars.

To achieve this, a temporary model

$${{Θ}^{′}}_{i}$$

using S_{wm} to maximize the identification loss on D_{wm} may be trained, for which D_{wm} may be used to compute a validation loss to adjust the parameters of S_{wm}. The entire problem may be formulated in a local bi-level optimization schema, where “local” means within a single phase, as

$$\begin{matrix}{S}_{w m} = \text{arg} {max}_{{S}_{w m}} {L}_{c} \left({Θ}^{′} \left({S}_{w m}\right) ; {D}_{w m}\right) \\ \text{s} . \text{t} . {Θ}^{′} \left({S}_{w m}\right) = arg {min}_{Θ} {L}_{c} \left(Θ ; {S}_{w m}\right) .\end{matrix}$$

Solving Equation (3) may comprise a process of moving S_{wm} toward the decision boundary, and yielding a small loss on D_{wm}. Through embedding the exemplars S_{wm} into the model, it results in robust identification of D_{wm}.

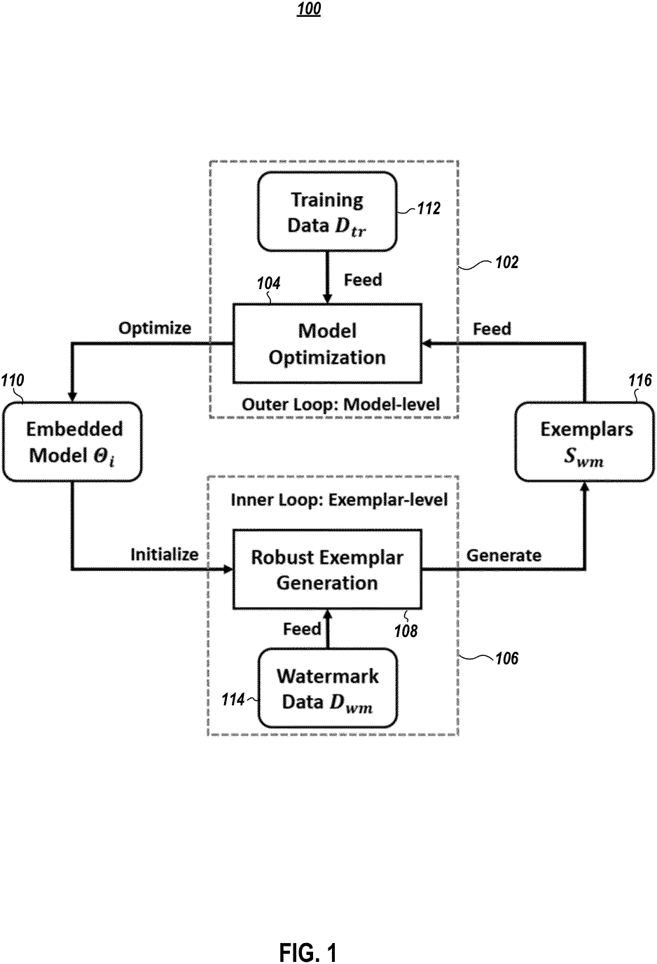

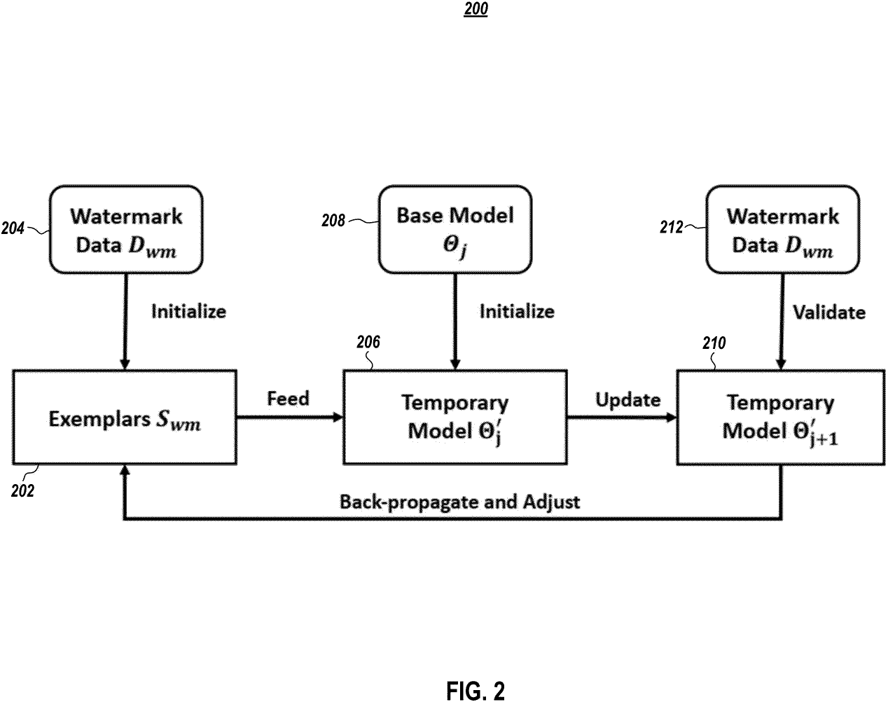

FIG. 2 illustrates a conceptual representation of an inner loop optimization training flow 200 for optimizing S_{wm} . As demonstrated in FIG. 2, the image-size parameters of the exemplars 202 (S_{wm}) are initialized by a subset of the watermark data 204 (D_{wm}). A temporary model 206 (0') is initialized with a base model 208 (Θⱼ, obtained in the outer loop as discussed above). The temporary model 206 (Θʹ) is trained for a one or more iterations by gradient descent on S_{wm}:

$${{Θ}^{′}}_{j + 1} ← {{Θ}^{′}}_{j} - {α}_{2} ∇ {}_{{{Θ}^{′}}_{j}} {L}_{c} \left({{Θ}^{′}}_{j} ; {S}_{j}\right) , \text{s} . \text{t} . {{Θ}^{′}}_{0} = {Θ}_{i} ,$$

where α₂ is the learning rate of fine-tuning temporary models, j is the iteration number in the inner loop optimization, and Θⱼ₊ₗ is the updated temporary model 210. As

$${{Θ}^{′}}_{j}$$

and Sⱼ are both differentiable, the loss of

$${{Θ}^{′}}_{j}$$

on D_{wm} (watermark data 212) may be computed, and this validation loss may be back-propagated to optimize Sⱼ,

$${S}_{j + 1} ← {S}_{j} + {β}_{1} {∇}_{{D}_{w m}} {L}_{c} \left({{Θ}^{′}}_{j} ; {D}_{w m}\right) , \text{s} \text{.t} \text{.} {\text{S}}_{0} ⊂ {D}_{w m} ,$$

where β₁ is the learning rate. In this step, the validation gradients may be backpropagated to the input layer through rolling all training gradients of model weights

$${{Θ}^{′}}_{j}$$

(e.g., via the chain-rule of backpropagation). Since the batch size of Sⱼ may be different from D_{wm}, the gradient on D_{wm} may be clustered and reshaped to correspond to the size of Sⱼ.

### 4. Masked Adaptive Optimization Embodiments

Conventional embedding processes typically require a retraining process, which leads to expensive computational costs, particularly for DNNs with large numbers of parameters. Moreover, optimizing all model parameters may greatly affect the original model functionality. To this end, watermarking processes of the present disclosure may adapt the concept of fault attacks and may utilize a masked optimization for watermarking. To preserve model functionality, disclosed embodiments utilize a mask to perform the embedding so that the essential parameters of model functions may be substantially frozen or unaltered when embedding watermarks on parameter space Θ.

When learning the model Θ, the parameters may be updated with a mask M, instead of directly optimizing all the parameters. In such implementations, during training, both prediction loss and watermarking loss (refer to Eq. (2)) may be used. For example, where ⊙ denotes the element-wise product, the objective function Eq. (2) discussed above may be formulated as:

$${L}_{a U} = λ {L}_{c} \left(M ⊙ Θ ; {D}_{t r}\right) + \left(1 - λ\right) {L}_{c} \left(M ⊙ Θ ; {S}_{w m}\right) .$$

Specifically, the most effective parameters in the DNN model to be optimized for watermark embedding may be located. The method aims to find the parameters on which the weight update could most easily manipulate the labels of key samples (S_{wm}) while preserving the original predictions on natural inputs (Dₜᵣ). To achieve this goal, the mask may be generated via the observation of the gradient of on Dₜᵣ and S_{wm}. Generally, the candidate parameters should have large gradient values over S_{wm}, but close to zero gradient values over Dₜᵣ. Formally, the mask, defined below as C, may be computed as:

$$\begin{matrix}C = {H}_{s} ∩ {H}_{t} \\ s . t . {H}_{s} = {\text{Top}}_{N} \left\{\frac{1}{\left|{S}_{w r n}\right|} {\sum }_{\left({x}_{s} , {y}_{s}\right) ∈ {S}_{w m}} \left|{∇}_{Θ} l \left(\left(f \left({\text{X}}_{s}\right) , {y}_{s}\right)\right)\right|\right\} , \\ {H}_{t} = {\text{Top}}_{N} \left\{- \frac{1}{\left|{D}_{l r}\right|} {\sum }_{\left({\text{x}}_{t} , {y}_{\text{t}}\right) ∈ {D}_{t , r}} \left|{∇}_{Θ} l \left(f \left({\text{X}}_{l}\right) , {y}_{t}\right)\right|\right\}\end{matrix}$$

To this end, the top N parameters of Θ may be prioritized according to the ranking, and the model may be optimized with the masked gradient descent:

$$\begin{matrix}Θ = Θ - {α}_{1} \left[\text{M} ⊙ {∇}_{Θ} L \left(Θ ; {S}_{w r n}\right) + \overline{\text{M}} ⊙ {∇}_{Θ} L \left(Θ ; {D}_{t r}\right)\right] \\ \text{s} \text{.t} \text{.} {\left[\text{M}\right]}_{k} = \left\{\begin{matrix}1 , & k ∈ C \\ 0 , & k ∉ C\end{matrix} , {\left[\overline{\text{M}}\right]}_{k} = \left\{\begin{matrix}0 , & k ∈ C \\ 1 , & k ∉ C\end{matrix}\right)\right)\end{matrix}$$

The hard-mask M may exploit the gate mechanism, which enables an adaptive optimization over a partial of neural structures.

### 5. Example Method Embodiments

An example methodology embodiment for implementing bi-level optimization for DNN watermarking, in accordance with the present disclosure, is provided below.

Methodology 1 Embodiment: Bi-Level Optimization for DNN watermarking Input: Data Dₜᵣ, D_{wm}, and Model Θₚᵣₑ Output: Authenticated DNN Model Θ_{wm}

1. for i = 1,.., N do (Outer Loop)
2. if i = 1,
3. Initialize weights Θʹ = Θₚᵣₑ
4. else
5. Θʹ = Θᵢ₋₁
6. Initialize S₀ c D_{wm}
7. for j= 1,.., M do (Inner Loop)
8. Adjust weight Sʹⱼ using Θʹ by Equation (5)
9. Update weight Θ using Sʹⱼ by Equation (4)
10. end for
11. Initialize S_{wm} = S'M and sample Sₜᵣ c Dₜᵣ
12. for any layer l in the DNN do
13. Compute Cₗ by Equation (6)
14. Update [Θᵢ]ₗ with the mask by Equation (7)
15. end for
16. end for

Implementing methodology 1 to facilitate robust DNN watermarking may provide a number of advantages. For example, to preserve the function of the DNN model, a few layers (e.g., one or more final layers, such as the last 5 or fewer layers) may be chosen to update the weight parameters, instead of all parameters. Steps 12-15 show fine-tuning the several layers of the DNN structure for watermarking. Furthermore, the learning bias may be reduced via balancing sample sizes between the watermarking and training samples. As shown in Step 11, the watermark batch in S_{wm} may be comparable with that in Sₜᵣ.

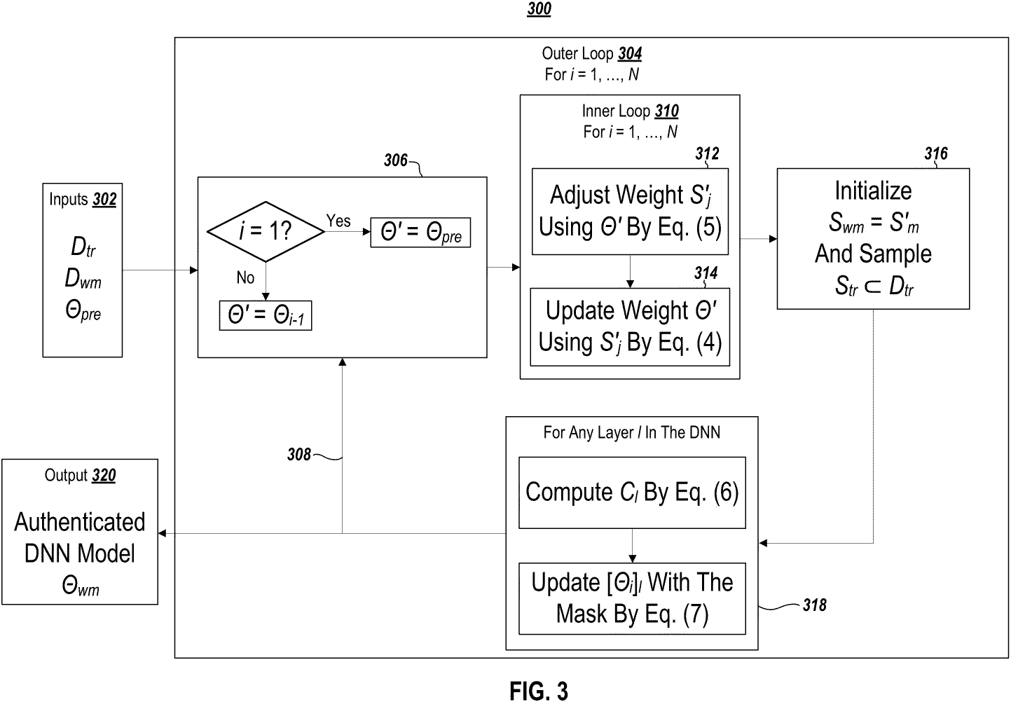

FIG. 3 illustrates an example flow diagram 300 depicting example acts associated with bi-level optimization for DNN watermarking. For example, flow diagram 300 illustrates inputs 302, which may comprise Dₜᵣ (e.g., training data or natural input 112, as discussed above), D_{wm} (e.g., watermark data or watermarks 114, as discussed above), and Θₚᵣₑ (e.g., model parameters of a pretrained model). Flow diagram 300 illustrates an example outer loop 304, which comprises various acts associated with the model-level problem as discussed hereinabove. The acts associated with the outer loop 304 may be performed until a particular stop condition is satisfied (e.g., until performance of a predetermined number of iterations is detected, as indicated in the outer loop 304 of FIG. 3 by “For i = 1, ..., N”).

As shown in FIG. 3, the outer loop 304 includes act 306, wherein Θʹ is initialized (e.g., parameters of a temporary model, as discussed above). In the example of FIG. 3, according to act 306, Θʹ is initialized as Θₚᵣₑ if i = 1, and where Θʹ is otherwise initialized as Θᵢ₋₁ (e.g., as determined by a previous iteration of the outer loop 304, indicated in FIG. 3 by arrow 308). FIG. 3 also shows initialized Θ (defined according to act 306) utilized in an inner loop 310, which may comprise various acts associated with the exemplar-level problem as discussed hereinabove. Similar to the outer loop 304, processes associated with the inner loop 310 may be performed until a particular stop condition is satisfied (e.g., until performance of a predetermined number of iterations is detected, as indicated in the inner loop 310 of FIG. 3 by “For j = 1, ..., M”).

In the example of FIG. 3, the inner loop 310 includes act 312, where the weight(s) of

$${{S}^{′}}_{j}$$

is/are adjusted using Θʹ by Eq. (5) discussed hereinabove. The inner loop 310 of FIG. 3 also includes act 314, where the weight(s) of Θʹ is/are adjusted using

$${{S}^{′}}_{j}$$

(e.g., as updated according to act 312) by Eq. (4) discussed hereinabove.

Based on output of the inner loop 310 (e.g., adjusted

$${{S}^{′}}_{M}$$

and updated Θʹ), the outer loop 304 of FIG. 3 includes act 316, where S_{wm} (e.g., exemplars, as discussed above) is/are initialized as

$${{S}^{′}}_{m}$$

and where Sₜᵣ is sampled as a subset of Dₜᵣ. FIG. 3 further illustrates act 318 of the outer loop 304, where act 318 can be performed for one or more layers, l, of the DNN model (e.g., one or more final layers). Act 318 includes utilizing output of act 316 to compute Cₗ (e.g., a mask, as discussed above) by Eq. (6) and updating [Θ]ₗ (e.g., DNN model parameters) using the mask Cₗ by Eq. (7) discussed above. At this point, where i < N , the updated DNN model parameters Θᵢ determined according to act 318 may be utilized to initialize parameters of a subsequent temporary model

$${{Θ}^{′}}_{i + 1} ,$$

according to act 306 of the outer loop 304 and as indicated in FIG. 3 by arrow 308. Where i = N, the updated DNN model parameters Θᵢ determined according to act 318 may be used to define output 320 comprising an authenticated or watermarked DNN model Θ_{wm}.

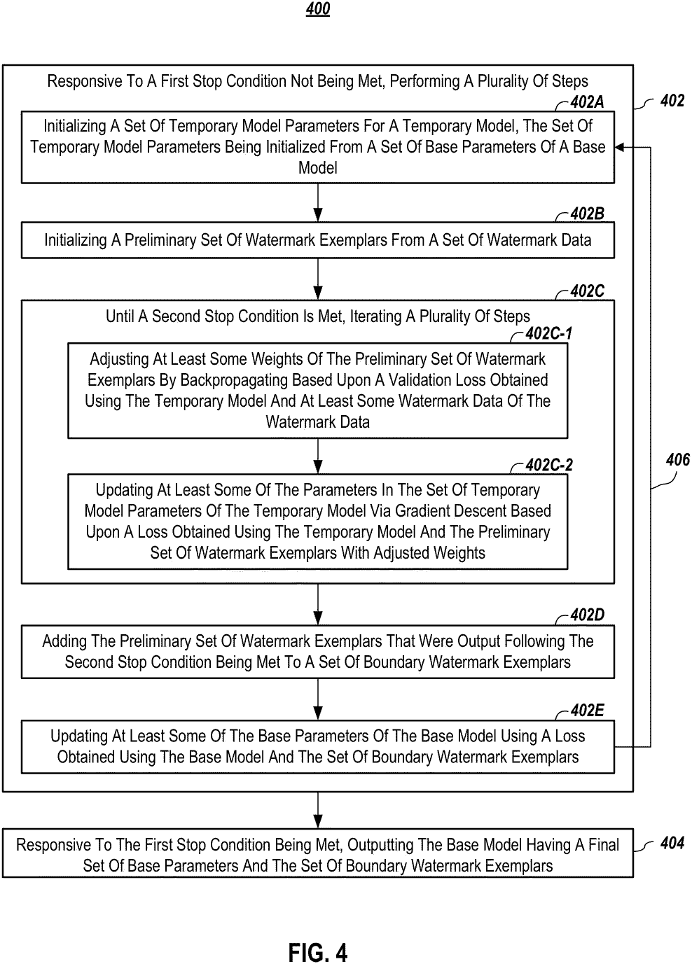

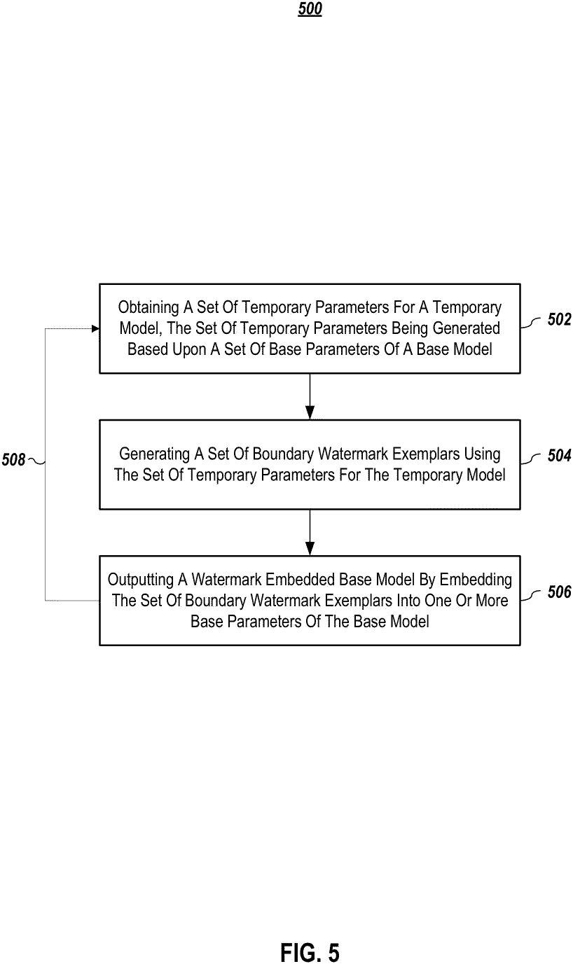

FIGS. 4 and 5 illustrate example flow diagrams 400 and 500, respectively, depicting acts associated with watermarking a deep neural network. As noted above, (1) certain steps may optionally be performed; (2) steps may not be limited to the specific order set forth herein; (3) certain steps may be performed in different orders; and (4) certain steps may be done concurrently.

Act 402 of flow diagram 400 includes, responsive to a first stop condition not being met, performing a plurality of steps. In some instances, the first stop condition comprises completion of a first predetermined number of iterations. Act 402 generally corresponds to the “outer loop” discussed hereinabove.

Step 402A of act 402 includes initializing a set of temporary model parameters for a temporary model, the set of temporary model parameters being initialized from a set of base parameters of a base model. In some instances, the base model comprises a previously trained base model or a base model from a previous iteration (see arrow 406 of FIG. 4). The temporary model parameters may correspond to 0', as described herein.

Step 402B of act 402 includes initializing a preliminary set of watermark exemplars from a set of watermark data. Step 402C of act 402 includes, until a second stop condition is met, iterating a plurality of steps. In some instances, the second stop condition comprises completion of a second predetermined number of iterations. Step 402C generally corresponds to the “inner loop” discussed hereinabove. The preliminary watermark exemplars may correspond to Sʹ, as described herein. The watermark data may correspond to D_{wm} as described herein.

Step 402C-1 of Step 402C includes adjusting at least some weights of the preliminary set of watermark exemplars by backpropagating based upon a validation loss obtained using the temporary model and at least some watermark data of the watermark data (e.g., utilizing Eq. (5)). Step 402C-2 of step 402C includes updating at least some of the parameters in the set of temporary model parameters of the temporary model via gradient descent based upon a loss obtained using the temporary model and the preliminary set of watermark exemplars with adjusted weights (e.g., utilizing Eq. (4)).

Upon satisfaction of the second stop condition (e.g., completion of the “inner loop”), step 402D of act 402 includes adding the preliminary set of watermark exemplars that were output following the second stop condition being met to a set of boundary watermark exemplars (e.g., S_{wm}). Furthermore, Step 402E of act 402 includes updating at least some of the base parameters of the base model using a loss obtained using the base model and the set of boundary watermark exemplars.

In some instances, the base parameter(s) of the base model that become updated are associated with one or more layers of the base model (e.g., [Θ]₁). For example, the one or more layers of the base model may comprise one or more final layers of the base model. Furthermore, in some instances, updating the base parameter(s) of the base model may include generating a mask (e.g., C1) and updating the base parameter(s) of the base model via masked gradient descent based upon (i) the mask, (ii) the loss obtained using the base model and the set of boundary watermark exemplars (referred to in step 402E), and (iii) a loss obtained using the base model and the one or more natural inputs (e.g., via Eq. (7)).

In some implementations, the mask used for the masked gradient descent to update the base parameter(s) is generated based upon (i) one or more first gradients obtained using the base model and one or more natural inputs and (ii) one or more second gradients obtained using the base model and the set of boundary watermark exemplars. For example, the mask may be generated by (i) generating a first ranked index of base parameters of the base model based upon the one or more first gradients, (ii) generating a second ranked index of base parameters of the base model based upon the one or more second gradients, and (iii) generating the mask as an intersection of at least a portion of the first ranked index and at least a portion of the second ranked index (e.g., via Eq. (6)).

When the first stop condition is not met, the base parameter(s) updated according to step 402E may be used to initialize a subsequent set of temporary model parameters for a subsequent iteration of the outer loop (e.g., act 402). Act 404 of flow diagram 400 includes, responsive to the first stop condition being met, outputting the base model having a final set of base parameters and the set of boundary watermark exemplars (e.g., Θ_{wm}). In some instances, the final set of base parameters is based upon the at least some of the base parameters that were updated using the loss obtained using the base model and the set of boundary watermark exemplars.

Act 502 of flow diagram 500 of FIG. 5 includes obtaining a set of temporary parameters for a temporary model, the set of temporary parameters being generated based upon a set of base parameters of a base model. In some instances, the base model comprises (i) a pretrained model or (ii) a previous watermark embedded base model. The previous watermark embedded base model may result from a previous embedding of a preceding set of boundary watermark exemplars into a previous base model (e.g., see arrow 508 of FIG. 5). As noted above, the temporary parameters may correspond to 0'.

Act 504 of flow diagram 500 includes generating a set of boundary watermark exemplars using the set of temporary parameters for the temporary model. The boundary watermark exemplars may correspond to S_{wm}, as noted above. In some instances, the set of boundary watermark exemplars maximizes an identification loss of the temporary model on a set of watermark data (e.g., D_{wm}). In some implementations, generating the set of watermark exemplars in accordance with act 504 includes various steps, such as (i) obtaining a preliminary set of watermark exemplars, (ii) adjusting at least some weights of the preliminary set of watermark exemplars by backpropagating based upon a validation loss obtained using the temporary model and at least some watermark data of the set of watermark data (e.g., via Eq. (5)), and (iii) updating at least some of the parameters in the set of temporary parameters for the temporary model via gradient descent based upon a loss obtained using the temporary model and the preliminary set of watermark exemplars with adjusted weights (e.g., via Eq. (4)). In some instances, updating at least some of the parameters in the set of temporary parameters provides the set of boundary watermark exemplars that maximizes the identification loss of the temporary model on the set of watermark data.

In some implementations, pursuant to steps associated with act 504, the preliminary set of watermark exemplars includes a subset of the set of watermark data or a preliminary set of watermark exemplars with previously adjusted weights. Furthermore, backpropagating based upon the validation loss obtained using the temporary model and at least some watermark data of the set of watermark data may include determining a gradient using the temporary model and the set of watermark data and clustering and reshaping the gradient to correspond to a size of the preliminary set of watermark exemplars.

Act 506 of flow diagram 500 includes outputting a watermark embedded base model by embedding the set of boundary watermark exemplars into one or more base parameters of the base model. In some instances, the one or more base parameters of the base model are associated with one or more layers of the base model. Furthermore, in some instances, embedding the set of boundary watermark exemplars into the one or more base parameters of the base model comprises generating a mask and updating the one or more base parameters via masked gradient descent based upon (i) the mask, (ii) the loss obtained using the base model and the set of boundary watermark exemplars, and (iii) a loss obtained using the base model and the one or more natural inputs (e.g., via Eq. (7)).

In some instances, the mask associated with act 506 is generated based upon (i) one or more first gradients obtained using the base model and one or more natural inputs and (ii) one or more second gradients obtained using the base model and the set of boundary watermark exemplars. For example, the mask may be generated by (i) generating a first ranked index of base parameters of the base model based upon the one or more first gradients, (ii) generating a second ranked index of base parameters of the base model based upon the one or more second gradients, and (iii) generating the mask as an intersection of at least a portion of the first ranked index and at least a portion of the second ranked index (e.g., via Eq. (6)).

In some implementations, embedding the set of boundary watermark exemplars into the base parameters of the base model as noted above with reference to act 506 contributes to an ability of the watermark embedded base model to identify the set of watermark data despite subsequent fine-tuning of the watermark embedded base model. Furthermore, in some instances, embedding the set of boundary watermark exemplars into the one or more base parameters of the base model preserves predictions of the watermark embedded base model on one or more natural inputs.

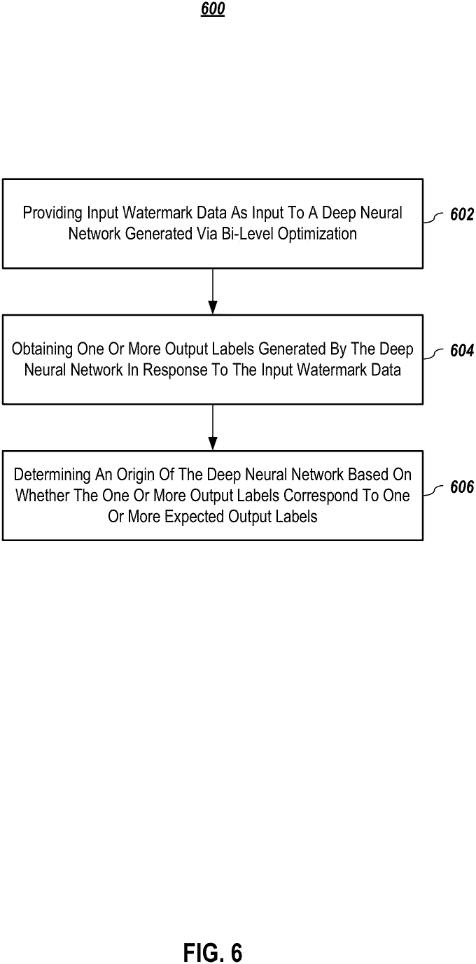

FIG. 6 illustrate example an example flow diagrams 600 depicting acts associated with detecting a watermarked deep neural network. Act 602 of flow diagram 600 includes providing input watermark data as input to a deep neural network generated via bi-level optimization. For example, the deep neural network referred to in act 602 may be generated according to flow diagram 400, flow diagram 500, and/or other techniques discussed herein. Act 604 of flow diagram 600 includes obtaining one or more output labels generated by the deep neural network in response to the input watermark data. Act 606 of flow diagram 600 includes determining an origin of the deep neural network based on whether the one or more output labels correspond to one or more expected output labels. As noted above, the output labels corresponding to one or more expected output labels (known to the model owner and/or creator) may provide a strong indication of the source of the deep neural network that receives the input watermark data according to act 602. Thus, a DNN model owner and/or creator may employ acts associated with flow diagram 600 to determine misappropriation of DNN models and may pursue additional actions to remedy an unauthorized use of the deep neural network.

### D. Experiments

It shall be noted that these experiments and results are provided by way of illustration and were performed under specific conditions using a specific embodiment or embodiments; accordingly, neither these experiments nor their results shall be used to limit the scope of the disclosure of the current patent document.

### 1. Experimental Setup

### a) Base Models

In the experiments included herein trained various types of pretrained models (including LeNet5, VGG-9, VGG-16, and Inception-V3) for various image datasets (i.e., Dataset 1, Dataset 2, Dataset 3, and Dataset 4) and found that the trained models achieved test accuracy that is consistent with or superior to existing techniques. The experiments utilized the PaddlePaddle deep learning platform.

### b) Transformation Attacks

The experiments provided herein evaluate the robustness of the disclosed methods against the following three widely-used transformation attacks: Fine-Tuning, Pruning, and Watermark Overwriting. Fine-tuning can be considered as a transformation attack that an adversary may use to remove the watermark while preserving the model accuracy by retraining part of the network layers with original data (e.g., natural input samples). In the experiments provided herein, the watermarked models were fine-tuned using the corresponding validation data. Model pruning is a popular technique to compress a well-trained model to accelerate the computation and reduce memory requirement, while preserving of the inference accuracy. An adversary may employ pruning in an attempt to alter the embedded watermarks. Watermark overwriting may be employed by an adaptive and intelligent adversary who has the knowledge of the watermarking technique utilized by a model owner and/or creator (but not the specific embedded watermark). To perform such an attack, the adversary selects a new set of watermark key samples and uses the method used by the model owner/creator to embed a second watermark in hopes of overwriting the first watermarking without affecting the inference accuracy. In the present experiments, the second watermark was selected randomly.

### c) Performance Metrics

Fidelity is characterized by authentication success rate Rₐᵤₜₕ, loss of accuracy Rₗₒₛₛ, and number of modified parameters. Among these, Rₐᵤₜₕ evaluates the percentage of watermark samples that are embedded successfully into the DNN models. It was expected that the authentication success rate Rₐᵤₜₕ would be high while function loss rate Rₗₒₛₛ would be low, so that the watermarked model retains accuracy on normal test data.

Robustness is evaluated against transformation attacks. Function preserved rate Rₚᵣₑₛ was used to quantify the preserved prediction capability, which is evaluated on the validation dataset. The embedded watermark should not be removed when Rₚᵣₑₛ for the natural inputs remains high, and the degradation of Rₐᵤₜₕ should be much smaller than that of Rₚᵣₑₛ.

Capacity represents the amount of information the proposed technique can embed into the target DNN model without violating other requirements.

### (d) Parameter Setting

For all experiments discussed herein, the top 2.5% of masked parameters (denoted as N in Eq. (6)) were selected. According to the “Methodology 1 Embodiment,” the number of inner loop iterations was set to M = 3, and number of outer loop iterations was set to N = 10. For each dataset, the same learning rate of α₁ = α₂ = β₁ was used in both exemplar optimizations in Eq. (4) and Eq. (5) and in the model optimization in Eq. (7). Specifically, the learning rate was set to be 0.002 for Dataset 1, and 0.02 for Datasets 2, 3, and 4. For the number of key samples in D_{wm}, 30 was assigned in Dataset 1, and 60 was assigned in Datasets 2, 3, and 4.

### 2. Results

### a) Fidelity

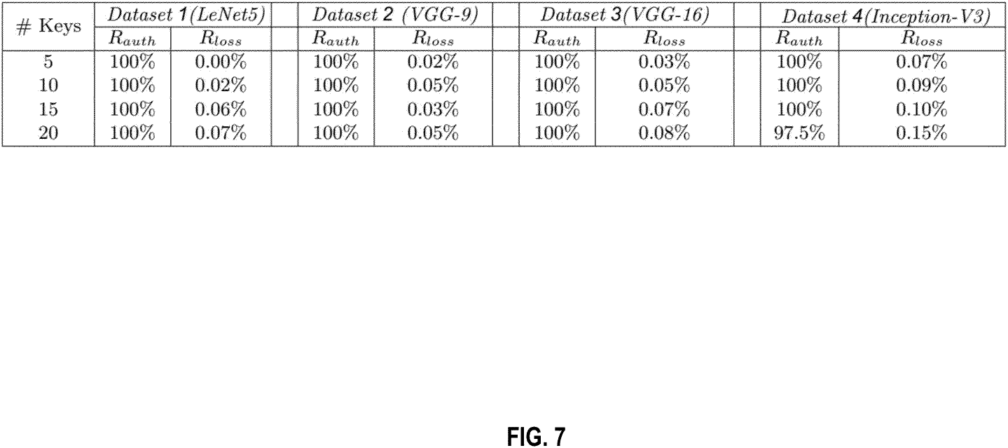

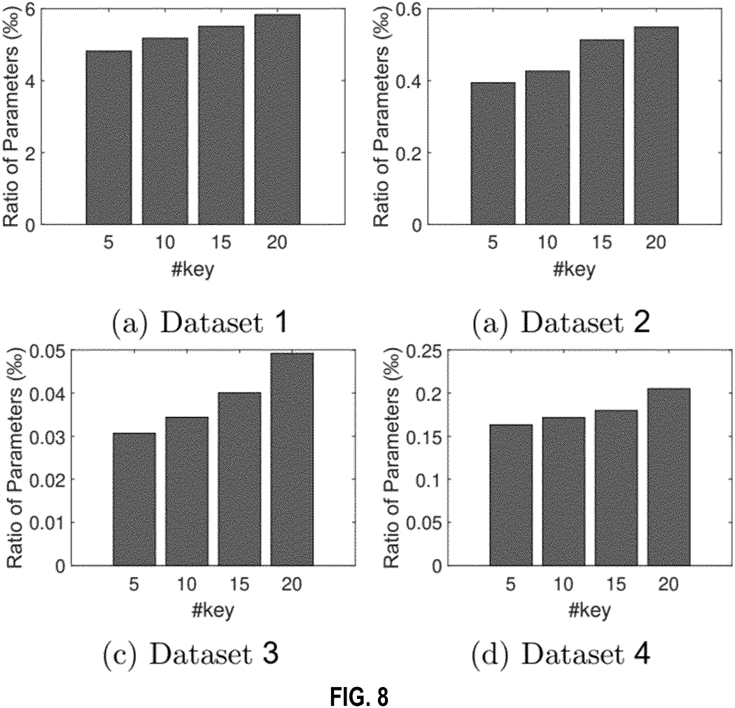

The experiments were run multiple times and the averaged authentication success rate and function loss rate were calculated, which are presented in FIG. 7. The results show that most of the selected watermark samples were successfully recognized given various numbers of keys. Specifically, the results show that the disclosed methods were able to achieve a high success rate without sacrificing the inference ability of the DNN models. For example, the models trained in accordance with the present disclosure successfully embedded all 20 keys into the Dataset 2 model with its function loss of less than 0.05%. Moreover, FIG. 8 shows the ratio of changed parameters when performing the watermark embedding over these DNN models. As is evident from FIG. 8, the models trained in accordance with the present disclosure only tune less than 0.005% and 0.025% weights of VGG-16 on Dataset 3 and Inception-V3 on Dataset 4, respectively, while achieving a high success rate of embedding and a low inference accuracy loss.

### b) Robustness

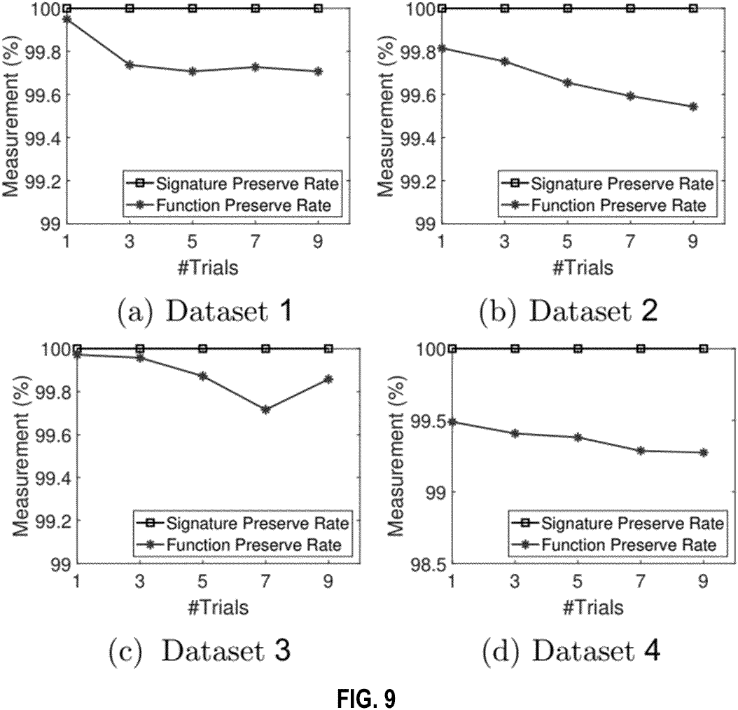

Fine-tuning: FIG. 9 presents the performance under the fine-tuning process. The results show that the disclosed techniques perform robustly towards the fine-tuning over all datasets. Specifically, as is evident from FIG. 9, although the function preserve rates drop after several trials of fine-tuning, the signature preserve rates still remain the same during the whole process.

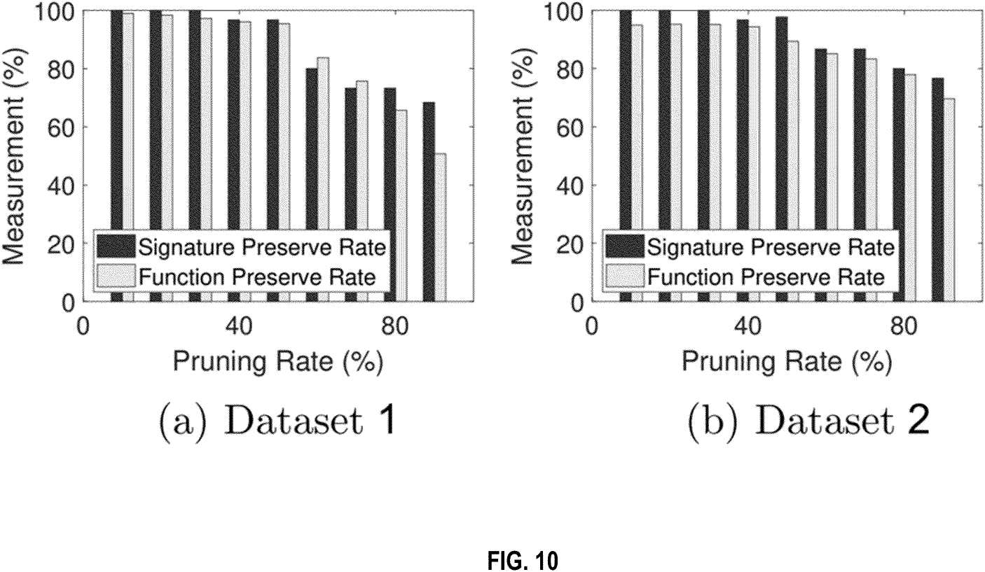

Pruning: FIG. 10 shows the performance impacts on watermarking embedding and inference ability under an increasing pruning rate. Case studies were conducted on Dataset 1 and Dataset 2, as similar results are observed on the other datasets. For Dataset 2, even after 50% of pruning rate, the model trained in accordance with the present disclosure still maintained no loss on identification accuracy. With a higher pruning rate, the inference accuracy starts to drop dramatically. In addition, as is evident from FIG. 10, models trained in accordance with the present disclosure perform better on more complex DNN models, which demonstrates its robustness over large parameter spaces.

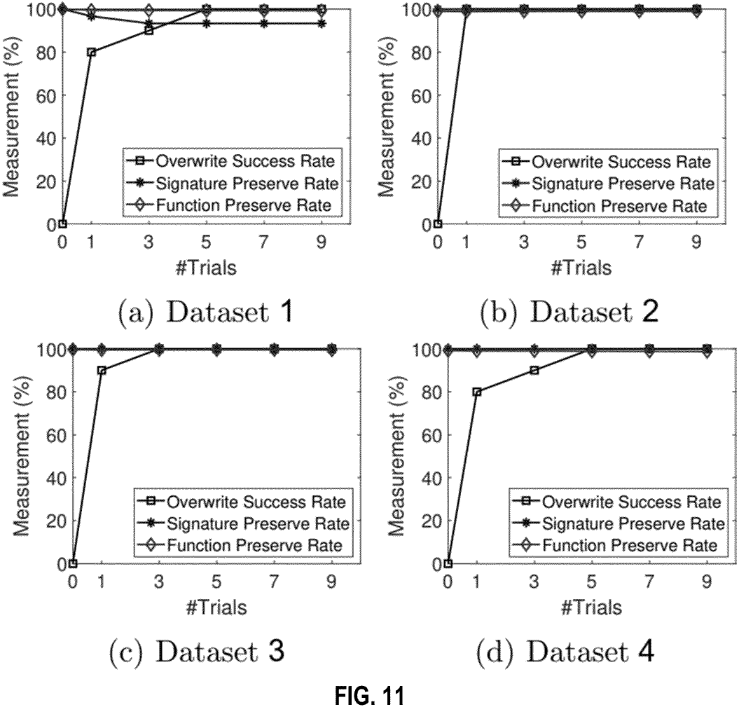

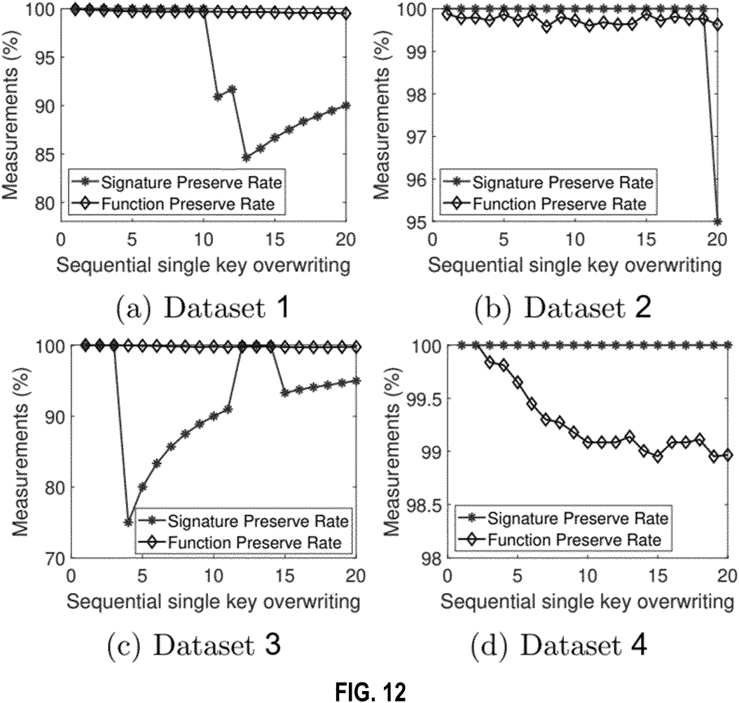

Watermark overwriting: the robustness of the disclosed methods against the watermark overwriting scenario was evaluated, where an adversary seeks to insert additional watermarks into a model in order to disable the recognition of original watermarks. In the experiments provided herein, the overwriting attack was performed in two different settings: 1) the same size of new key samples were sampled, and the same embedding process as the original key set was performed; 2) key samples were embedded one by one with only one, and each key sample was not executed until its previous key sample was embedded successfully. FIG. 11 presents the performance of conventional overwriting process in the first setting. As shown, the models trained in accordance with the present disclosure were consistently robust against the overwriting over all the datasets. Specifically, the watermark embedding is more robust over a more complex DNN structure. FIG. 12 depicts the results of the sequential overwriting process in the second setting, showing that this setting performs relatively unstable compared to overwriting all key samples. It nonetheless still achieves promising performance on Datasets 2, 3, and 4 with 95%, 95%, and 100% success rates, respectively.

### c) Capacity

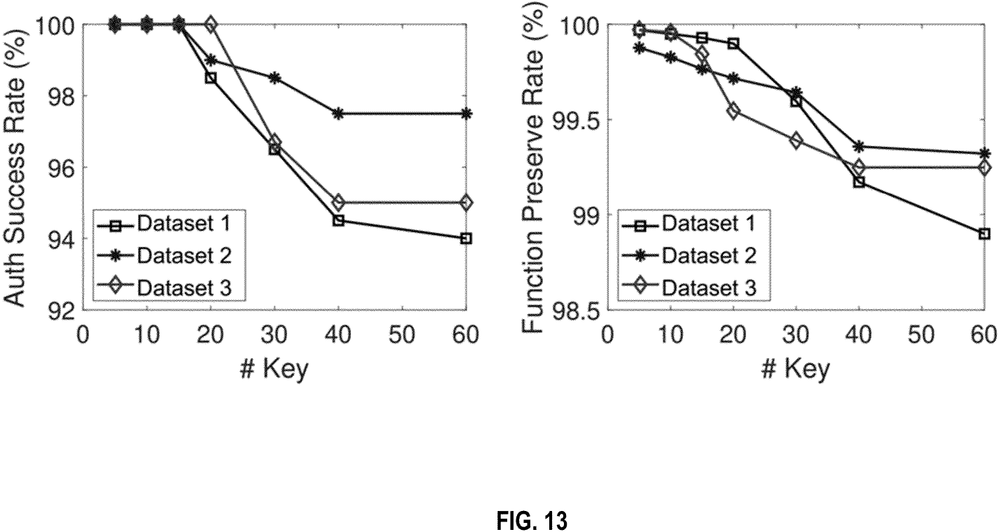

The capacity with respect to large numbers of key sample embedding was evaluated, as shown in FIG. 13. Obviously, embedding on more key samples results in lower authentication rates and lower function preserve rate, since algorithms require more modification to the weights. However, due to the masked optimization strategy discussed herein that only updates the parameter weights with a small impact on the previous learned knowledge, the disclosed techniques can maintain a comparable authentication rate (e.g., more than 94%) and function preserve rate (e.g., around 99.0% for 60 key embedding). It can also be inferred that the disclosed methods perform more stable on complex datasets.

### 3. Discussion and Some Conclusions/Observations

Based on the experimental results provided herein, it can be concluded that watermarks embedded according to embodiments of the present disclosure satisfy the requirements for an effective and robust IP protection tool. By leveraging the bi-level optimization strategy, disclosed techniques are able to provably enhance robustness while maintaining an extremely small inference accuracy loss. Besides, the watermarking framework disclosed herein exhibits consistent performance across various DNN architectures on a wide range of datasets.

To further demonstrate the advantage of the methods discussed herein, prior DNN watermarking methods were compared to embodiments of the present methods from the perspectives of fidelity and robustness (it is noted that the different experiments have different settings and employ different architectures and hyperparameters; furthermore, the settings of transformation attacks might also vary largely across different works). Since the overwriting process is the same as watermarking, which results in less variation for evaluation, prior works that are evaluated against overwriting are compared to:

“Prior 1”: Yusuke Uchida, Yuki Nagai, Shigeyuki Sakazawa, and Shin'ichi Satoh. Embedding watermarks into deep neural networks. In Proceedings of the 2017 ACM on International Conference on Multimedia Retrieval (ICMR), pages 269-277, Bucharest, Romania, 2017.

“Prior 2”: Bita Darvish Rouhani, Huili Chen, and Farinaz Koushanfar. Deepsigns: an end-to-end watermarking framework for ownership protection of deep neural networks. In Proceedings of the Twenty-Fourth International Conference on Architectural Support for Programming Languages and Operating Systems (ASPLOS), pages 485-497, Providence, RI, 2019.

“Prior 3”: Yossi Adi, Carsten Baum, Moustapha Cisse, Benny Pinkas, and Joseph Keshet. Turning your weakness into a strength: Watermarking deep neural networks by backdooring. In Proceedings of the 27th USENIX Security Symposium (USENIX Security), pages 1615- 1631, Baltimore, MD, 2018.

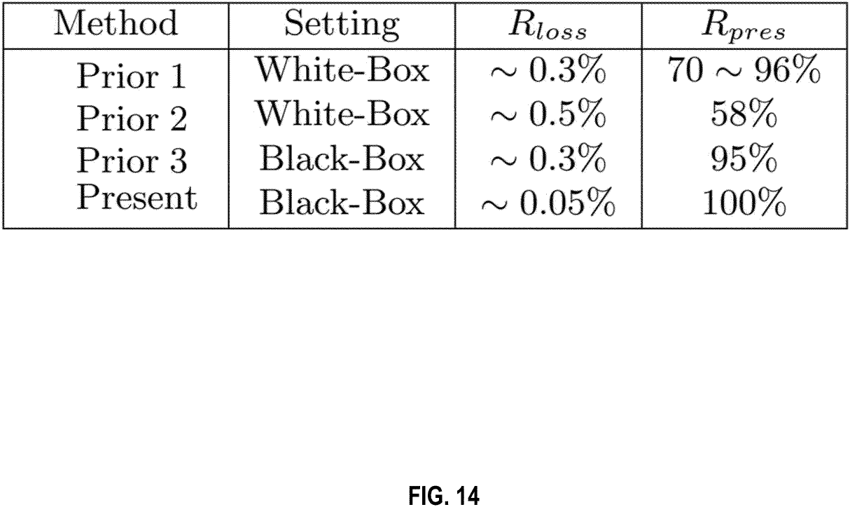

As most of these prior works were only evaluated on Dataset 2 and/or Dataset 1, Dataset 2 is considered for comparison, as presented in FIG. 14.

On Dataset 2, the tested embodiment only has a 0.05% accuracy loss for 20 key samples, while the white-box method in Prior 2 has around a 0.5% accuracy loss, and the black-box method (backdoor-based) in Prior 3 yields an about 0.3% accuracy loss under the same number of keys. As is evident from FIG. 14, the tested embodiment achieves a much better fidelity relative to prior methods, which is expected as the tested embodiment modify/modifies an extremely small number of parameters for embedding the watermark and hence have/has better control over the model behavior. Even for Dataset 4, for instance, the tested embodiment achieves a 100% Rₐᵤₜₕ with only a 0.1% accuracy loss.

When comparing the robustness against prior works, the performance of the Present method(s) is also superior. For example, the number of mismatches after overwriting on Dataset 2 is around 8.5 for 20 key samples in Prior 2, yielding a below 60% signature preserve rateRₚᵣₑₛ, while the Present method(s) achieve(s) almost 100% signature preserve rates in all the datasets under both settings of watermark overwriting as described above. While Prior 3 shows a decent performance against overwriting on Dataset 2, it suffers from a significant Rₚᵣₑₛ degradation on Dataset 3, under the same setting of fine-tuning a pre-trained model. In contrast, the Present method(s) achieve(s) a 100% signature preserve rate for Dataset 3 and even Dataset 4, as shown in FIG. 11.

The systems, methods, devices, and/or techniques of the present disclosure may leverage the concept of fault attacks to embed watermarks into a DNN model for IP protection. By exploiting the capability of embedding the desired behavior while modifying a tiny number of parameters, the disclosed embodiments formulate and develop a novel bi-level optimization to enhance the robustness of the watermarking. The experimental data included herein comprehensively evaluate the proposed algorithm over a wide range of settings and DNN architectures. The empirical results clearly demonstrate the superior performance of the disclosed embodiments.

### E. Computing System Embodiments

In one or more embodiments, aspects of the present patent document may be directed to, may include, or may be implemented on one or more information handling systems (or computing systems). An information handling system/computing system may include any instrumentality or aggregate of instrumentalities operable to compute, calculate, determine, classify, process, transmit, receive, retrieve, originate, route, switch, store, display, communicate, manifest, detect, record, reproduce, handle, or utilize any form of information, intelligence, or data. For example, a computing system may be or may include a personal computer (e.g., laptop), tablet computer, mobile device (e.g., personal digital assistant (PDA), smart phone, phablet, tablet, etc.), smart watch, server (e.g., blade server or rack server), a network storage device, camera, or any other suitable device and may vary in size, shape, performance, functionality, and price. The computing system may include random access memory (RAM), one or more processing resources such as a central processing unit (CPU) or hardware or software control logic, read only memory (ROM), and/or other types of memory. Additional components of the computing system may include one or more drives (e.g., hard disk drive, solid state drive, or both), one or more network ports for communicating with external devices as well as various input and output (I/O) devices, such as a keyboard, mouse, touchscreen, stylus, microphone, camera, trackpad, display, etc. The computing system may also include one or more buses operable to transmit communications between the various hardware components.

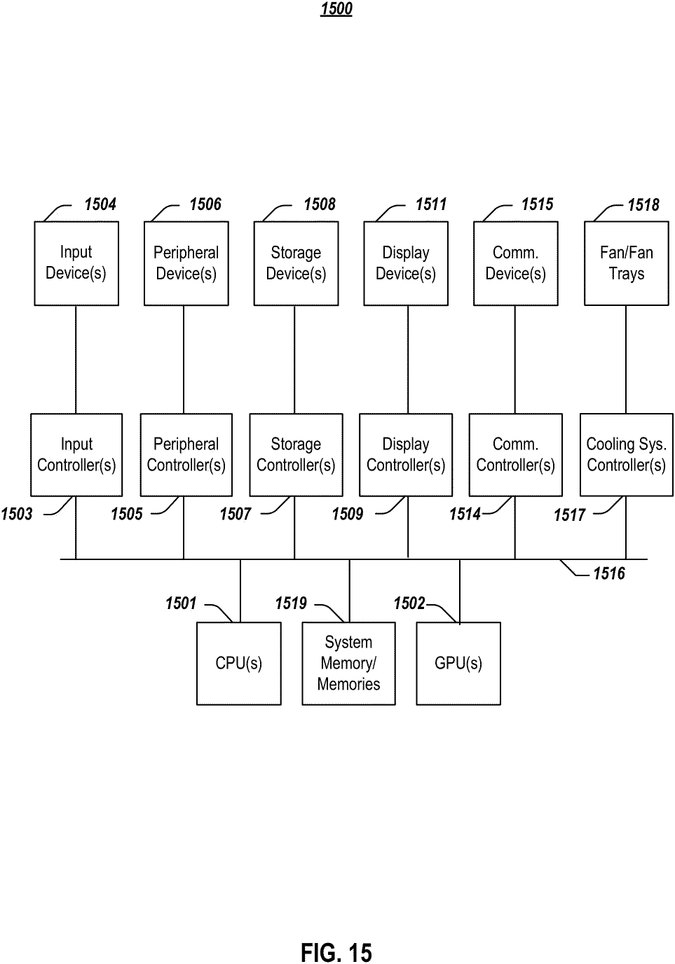

FIG. 15 depicts a simplified block diagram of an information handling system (or computing system), according to embodiments of the present disclosure. It will be understood that the functionalities shown for system 1500 may operate to support various embodiments of a computing system—although it shall be understood that a computing system may be differently configured and include different components, including having fewer or more components as depicted in FIG. 15.

As illustrated in FIG. 15, the computing system 1500 includes one or more CPUs 1501 that provides computing resources and controls the computer. CPU 1501 may be implemented with a microprocessor or the like, and may also include one or more graphics processing units (GPU) 1502 and/or a floating-point coprocessor for mathematical computations. In one or more embodiments, one or more GPUs 1502 may be incorporated within the display controller 1509, such as part of a graphics card or cards. Thy system 1500 may also include a system memory 1519, which may comprise RAM, ROM, or both.

A number of controllers and peripheral devices may also be provided, as shown in FIG. 15. An input controller 1503 represents an interface to various input device(s) 1504. The computing system 1500 may also include a storage controller 1507 for interfacing with one or more storage devices 1508 each of which includes a storage medium such as magnetic tape or disk, or an optical medium that might be used to record programs of instructions for operating systems, utilities, and applications, which may include embodiments of programs that implement various aspects of the present disclosure. Storage device(s) 1508 may also be used to store processed data or data to be processed in accordance with the disclosure. The system 1500 may also include a display controller 1509 for providing an interface to a display device 1511, which may be a cathode ray tube (CRT) display, a thin film transistor (TFT) display, organic light-emitting diode, electroluminescent panel, plasma panel, or any other type of display. The computing system 1500 may also include one or more peripheral controllers or interfaces 1505 for one or more peripherals 1506. Examples of peripherals may include one or more printers, scanners, input devices, output devices, sensors, and the like. A communications controller 1514 may interface with one or more communication devices 1515, which enables the system 1500 to connect to remote devices through any of a variety of networks including the Internet, a cloud resource (e.g., an Ethernet cloud, a Fiber Channel over Ethernet (FCoE)/Data Center Bridging (DCB) cloud, etc.), a local area network (LAN), a wide area network (WAN), a storage area network (SAN) or through any suitable electromagnetic carrier signals including infrared signals. As shown in the depicted embodiment, the computing system 1500 comprises one or more fans or fan trays 1518 and a cooling subsystem controller or controllers 1517 that monitors thermal temperature(s) of the system 1500 (or components thereof) and operates the fans/fan trays 1518 to help regulate the temperature.

In the illustrated system, all major system components may connect to a bus 1516, which may represent more than one physical bus. However, various system components may or may not be in physical proximity to one another. For example, input data and/or output data may be remotely transmitted from one physical location to another. In addition, programs that implement various aspects of the disclosure may be accessed from a remote location (e.g., a server) over a network. Such data and/or programs may be conveyed through any of a variety of machine-readable medium including, for example: magnetic media such as hard disks, floppy disks, and magnetic tape; optical media such as compact discs (CDs) and holographic devices; magnetooptical media; and hardware devices that are specially configured to store or to store and execute program code, such as application specific integrated circuits (ASICs), programmable logic devices (PLDs), flash memory devices, other non-volatile memory (NVM) devices (such as 3D XPoint-based devices), and ROM and RAM devices.

Aspects of the present disclosure may be encoded upon one or more non-transitory computer-readable media with instructions for one or more processors or processing units to cause steps to be performed. It shall be noted that the one or more non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the FIGS. and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that have computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magnetooptical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A computer-implemented method for watermarking a deep neural network, comprising:
responsive to a first stop condition not being met, performing steps comprising:
initializing a set of temporary model parameters for a temporary model, the set of temporary model parameters being initialized from a set of base parameters of a base model, the base model comprising a previously trained base model or a base model from a previous iteration;
initializing a preliminary set of watermark exemplars from a set of watermark data;
until a second stop condition is met, iterating steps comprising:
adjusting at least some weights of the preliminary set of watermark exemplars by backpropagating based upon a validation loss obtained using the temporary model and at least some watermark data of the watermark data; and
updating at least some of the parameters in the set of temporary model parameters of the temporary model via gradient descent based upon a loss obtained using the temporary model and the preliminary set of watermark exemplars with adjusted weights;
adding the preliminary set of watermark exemplars that were output following the second stop condition being met to a set of boundary watermark exemplars; and
updating at least some of the base parameters of the base model using a loss obtained using the base model and the set of boundary watermark exemplars; and
responsive to the first stop condition being met, outputting the base model having a final set of base parameters and the set of boundary watermark exemplars.

2. The computer-implemented method of claim 1, wherein the final set of base parameters is based upon the at least some of the base parameters that were updated using the loss obtained using the base model and the set of boundary watermark exemplars.

3. The computer-implemented method of claim 1, wherein the first stop condition comprises completion of a first predetermined number of iterations.

4. The computer-implemented method of claim 2, wherein the second stop condition comprises completion of a second predetermined number of iterations.

5. The computer-implemented method of claim 1, wherein updating the at least some of the base parameters of the base model comprises:
generating a mask based upon (i) one or more first gradients obtained using the base model and one or more natural inputs and (ii) one or more second gradients obtained using the base model and the set of boundary watermark exemplars; and
updating the at least some of the base parameters of the base model via masked gradient based upon (i) the mask, (ii) the loss obtained using the base model and the set of boundary watermark exemplars, and (iii) a loss obtained using the base model and the one or more natural inputs.

6. The computer-implemented method of claim 4, wherein generating the mask comprises:
generating a first ranked index of base parameters of the base model based upon the one or more first gradients;
generating a second ranked index of base parameters of the base model based upon the one or more second gradients; and
generating the mask as an intersection of at least a portion of the first ranked index and at least a portion of the second ranked index.

7. The computer-implemented method of claim 5, wherein the at least some of the base parameters of the base model are associated with one or more layers of the base model.

8. The computer-implemented method of claim 6, wherein the one or more layers of the base model comprise one or more final layers of the base model.

9. A computer-implemented method for watermarking a deep neural network, comprising:
obtaining a set of temporary parameters for a temporary model, the set of temporary parameters being generated based upon a set of base parameters of a base model;
generating a set of boundary watermark exemplars using the set of temporary parameters for the temporary model, the set of boundary watermark exemplars maximizing an identification loss of the temporary model on a set of watermark data; and
outputting a watermark embedded base model by embedding the set of boundary watermark exemplars into one or more base parameters of the base model.

10. The computer-implemented method of claim 9, wherein embedding the set of boundary watermark exemplars into the base parameters of the base model contributes to an ability of the watermark embedded base model to identify the set of watermark data despite subsequent fine-tuning of the watermark embedded base model.

11. The computer-implemented method of claim 10, wherein embedding the set of boundary watermark exemplars into the one or more base parameters of the base model preserves predictions of the watermark embedded base model on one or more natural inputs.

12. The computer-implemented method of claim 9, wherein the base model comprises (i) a pretrained model or (ii) a previous watermark embedded base model, the previous watermark embedded base model resulting from a previous embedding of a preceding set of boundary watermark exemplars into a previous base model.

13. The computer-implemented method of claim 9, wherein generating the set of watermark exemplars comprises:
obtaining a preliminary set of watermark exemplars;
adjusting at least some weights of the preliminary set of watermark exemplars by backpropagating based upon a validation loss obtained using the temporary model and at least some watermark data of the set of watermark data; and
updating at least some of the parameters in the set of temporary parameters for the temporary model via gradient descent based upon a loss obtained using the temporary model and the preliminary set of watermark exemplars with adjusted weights.

14. The computer-implemented method of claim 13, wherein the preliminary set of watermark exemplars comprises (i) a subset of the set of watermark data or (ii) a preliminary set of watermark exemplars with previously adjusted weights.

15. The computer-implemented method of claim 13, wherein backpropagating based upon the validation loss obtained using the temporary model and at least some watermark data of the set of watermark data comprises:
determining a gradient using the temporary model and the set of watermark data; and
clustering and reshaping the gradient to correspond to a size of the preliminary set of watermark exemplars.

16. The computer-implemented method of claim 13, wherein updating at least some of the parameters in the set of temporary parameters provides the set of boundary watermark exemplars that maximizes the identification loss of the temporary model on the set of watermark data.

17. The computer-implemented method of claim 9, wherein the one or more base parameters of the base model are associated with one or more layers of the base model.

18. The computer-implemented method of claim 9, wherein embedding the set of boundary watermark exemplars into the one or more base parameters of the base model comprises:
generating a mask based upon (i) one or more first gradients obtained using the base model and one or more natural inputs and (ii) one or more second gradients obtained using the base model and the set of boundary watermark exemplars; and
updating the one or more base parameters via masked gradient descent based upon (i) the mask, (ii) the loss obtained using the base model and the set of boundary watermark exemplars, and (iii) a loss obtained using the base model and the one or more natural inputs.

19. The computer-implemented method of claim 18, wherein generating the mask comprises:
generating a first ranked index of base parameters of the base model based upon the one or more first gradients;
generating a second ranked index of base parameters of the base model based upon the one or more second gradients; and
generating the mask as an intersection of at least a portion of the first ranked index and at least a portion of the second ranked index.

20. A computer-implemented method for detecting a watermarked deep neural network, comprising:
providing input watermark data as input to a deep neural network, the deep neural network being generated by:
obtaining a set of temporary parameters for a temporary model, the set of temporary parameters being generated based upon a set of base parameters of a base model;
generating a set of boundary watermark exemplars using the set of temporary parameters for the temporary model, the set of boundary watermark exemplars maximizing an identification loss of the temporary model on a set of watermark data; and
outputting the deep neural network by embedding the set of boundary watermark exemplars into one or more base parameters of the base model;
obtaining one or more output labels generated by the deep neural network in response to the input watermark data; and
determining an origin of the deep neural network based on whether the one or more output labels correspond to one or more expected output labels.
